(19) United States
(12) Patent Application Publication
(10) Pub. No.: US 2025/0062859 A1
(43) Pub. Date: Feb. 20, 2025

(54) NR SIDELINK SCI SOURCE AND DESTINATION PRUNING

(71) Applicant: QUALCOMM Incorporated, San Diego, CA (US)

(72) Inventors: Moshe BEN-ARI, Rehovot (IL); Ran BERLINER, Kfar Aviv (IL); Guy SPIEGELSTEIN, Nes-Ziona (IL); Peer BERGER, Hod Hasharon (IL)

(21) Appl. No.: 18/452,486

(22) Filed: Aug. 18, 2023

(51) Int. Cl. H04L 1/00; H04W 72/25

(52) U.S. Cl. CPC H04L 1/0061; H04W 72/25

(57) ABSTRACT

Method and apparatus for SCI source and destination pruning. The apparatus generates CRC bits corresponding to a payload. The apparatus combines the CRC bits with source information and destination information associated with transmission of the payload to generate a modified CRC. The apparatus transmits, to a second UE, the modified CRC and the payload. The modified CRC may be generated based on an XOR operation between the CRC bits corresponding to the payload and the source information and the destination information. The apparatus may map to a payload one or more bits that correspond to source information and destination information associated with transmission of the payload. The apparatus may transmit, to a second UE, the payload comprising the one or more bits that correspond to the source information and the destination information mapped to the payload.

### TECHNICAL FIELD

The present disclosure relates generally to communication systems, and more particularly, to a configuration for a sidelink control information (SCI) source and destination pruning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a relay UE. The device may be a processor and/or a modem at a relay UE or the relay UE itself. The apparatus generates cyclic redundancy check (CRC) bits corresponding to a payload. The apparatus combines the CRC bits with source information and destination information associated with transmission of the payload to generate a modified CRC. The apparatus transmits, to a second UE, the modified CRC and the payload.

In an aspect of the disclosure, a method, a computer-readable medium, and an apparatus are provided. The apparatus may be a device at a target UE. The device may be a processor and/or a modem at a target UE or the target UE itself. The apparatus receives, from a first UE, a modified cyclic redundancy check (CRC) and a payload, wherein the modified CRC comprises CRC bits corresponding to the payload and source information and destination information associated with transmission of the payload. The apparatus compares the modified CRC with a list of source information and destination information to derive the CRC bits corresponding to the payload and the source and destination information associated with transmission of the payload.

In an aspect of the disclosure, a method, a computer-readable medium, and an apparatus are provided. The apparatus may be a device at a relay UE. The device may be a processor and/or a modem at a relay UE or the relay UE itself. The apparatus maps to a payload one or more bits that correspond to source information and destination information associated with transmission of the payload. The apparatus transmits, to a second UE, the payload comprising the one or more bits that correspond to the source information and the destination information mapped to the payload.

In an aspect of the disclosure, a method, a computer-readable medium, and an apparatus are provided. The apparatus may be a device at a target UE. The device may be a processor and/or a modem at a target UE or the target UE itself. The apparatus receives, from a first UE, a payload comprising one or more bits that correspond to source information and destination information mapped to the payload. wherein the source information and the destination information are associated with transmission of the payload. The apparatus calculates a cyclic redundancy check (CRC) based on the payload received from the first UE, wherein the source information and the destination information mapped to the payload is excluded from the calculation of the CRC. The apparatus compares the source information and the destination information mapped to the payload with a list of source information and destination information in response to a CRC check pass of the CRC.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2 illustrates example aspects of a sidelink slot structure.

FIG. 3 is a diagram illustrating an example of a first device and a second device involved in wireless communication based, e.g., on sidelink.

FIG. 4 illustrates example aspects of sidelink communication between devices, in accordance with aspects presented herein.

FIG. 5 illustrates an example of generating a CRC associated with a payload.

FIG. 6 illustrates an example of generating a modified CRC associated with a payload.

FIG. 7 illustrates an example of generating a CRC associated with a payload comprising source and destination information.

FIG. 8 illustrates an example of generating a modified CRC associated with a payload.

FIG. 9 is a call flow diagram of signaling between a first UE and a second UE.

FIG. 10 is a call flow diagram of signaling between a first UE and a second UE.

FIG. 11 is a flowchart of a method of wireless communication.

FIG. 12 is a diagram illustrating an example of a hardware implementation for an example apparatus and/or network entity.

FIG. 13 is a flowchart of a method of wireless communication.

FIG. 14 is a flowchart of a method of wireless communication.

FIG. 15 is a diagram illustrating an example of a hardware implementation for an example apparatus and/or network entity.

FIG. 16 is a flowchart of a method of wireless communication.

FIG. 17 is a diagram illustrating an example of a hardware implementation for an example apparatus and/or network entity.

FIG. 18 is a flowchart of a method of wireless communication.

FIG. 19 is a flowchart of a method of wireless communication.

FIG. 20 is a diagram illustrating an example of a hardware implementation for an example apparatus and/or network entity.

### DETAILED DESCRIPTION

Sidelink transmission from one device to another device may be partitioned into physical channels, where the two main channels are PSCCH and PSSCH. The PSCCH carries information for demodulation of the PSSCH, known as SCI. Sidelink transmission may utilize a payload structure comprised of SCI1 and SCI2 in order to separate the control information and the additional information based on the desired cast type and the expected recipients. SCI1 is carried by the PSCCH and SCI2 is carried as part of the PSCCH. SCI2 may be transmitted as part of the data resources of PSSCH. SCI2 may be spread all over the slot which may reduce the available resources for the PSSCH data, based on the properties of SCI2 and its slot configuration.

In some instances, control data based pruning may be utilized. Initial and basic pruning may be performed by checking PSCCH CRC. The amount of PSSCH data received from multiple users over the entire BW may be very large, and a device may be limited by the amount of RBs it is capable to process (e.g., required capability may be preconfigured to be non-overlapping N_{RBs} according to BW), additional level of pruning may be required, even for passing CRC PSCCH. Such additional pruning may be based on SCI1 payload.

Pruning methodology having an improved performance may be based on using SCI2 information, namely the source identifier (ID) and destination ID. In order to minimize or save on redundant processing, pruning may be best held by SCI1 payload. In some instances, SCI2 demodulation performance optimization may include waiting until all PSSCH DMRS symbols are available, which may add latency to the overall demodulation timeline. SCI2 payload may be utilizing PSSCH resources that could be used for PSSCH data. As such, it may be advantageous to signal at least part of the SCI2 info on top of SCI1, without increasing SCI1 payload.

Aspects presented herein provide a configuration for SCI source and destination pruning. The disclosure may allow for the inclusion of source and destination information within SCI1 without increasing the payload size of SCI1.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

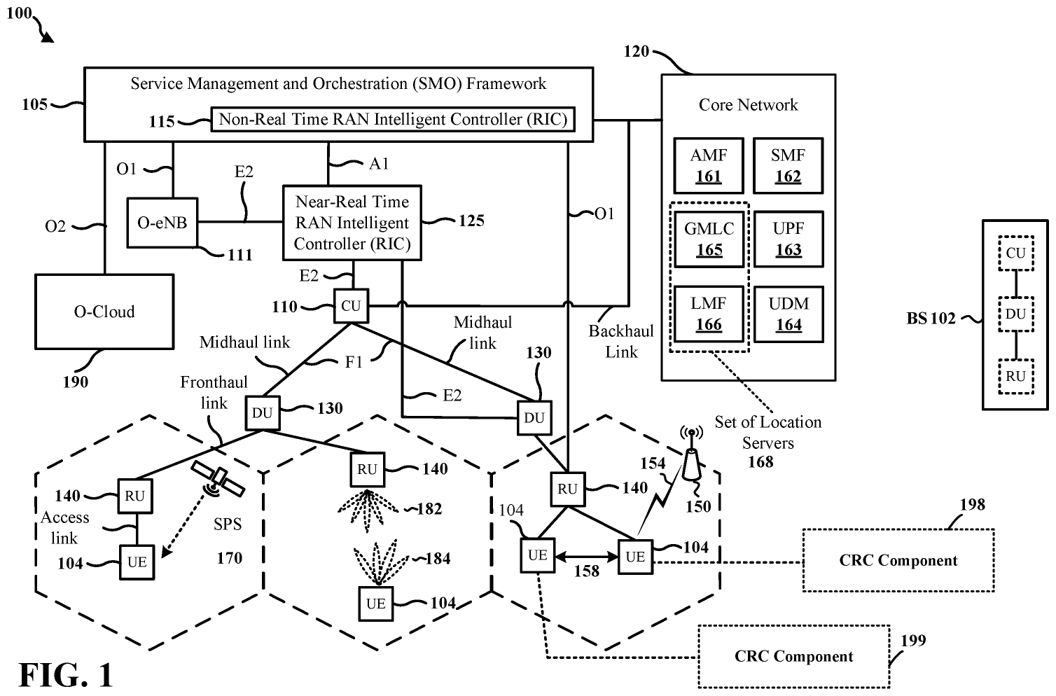

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

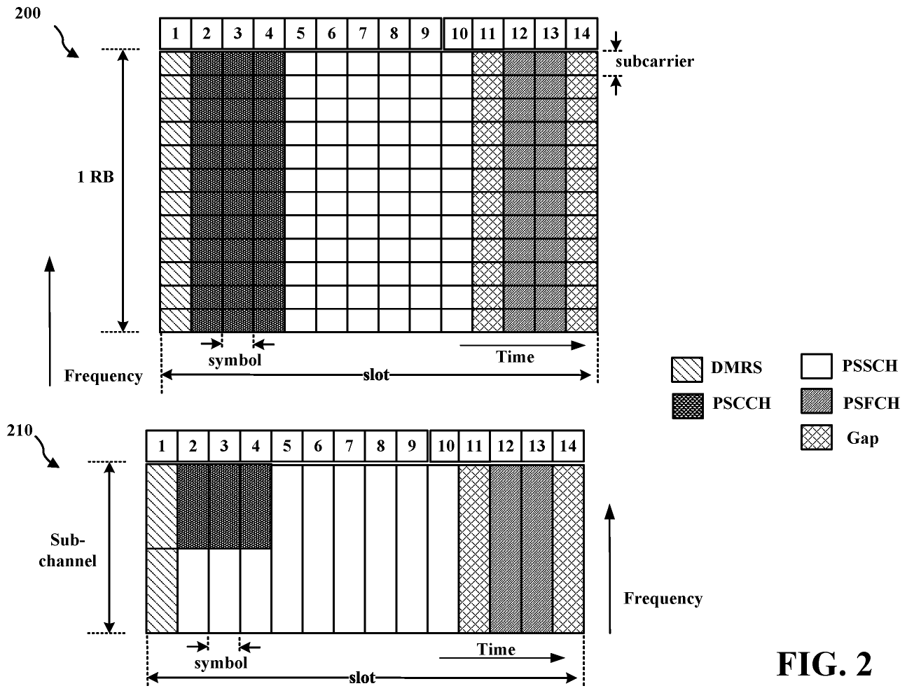

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as Road Side Unit (RSU) 407, etc. Sidelink communication may be exchanged using a PC5 interface, such as described in connection with the example in FIG. 2. Although the following description, including the example slot structure of FIG. 2, may provide examples for sidelink communication in connection with 5G NR, the concepts described herein may be applicable to other similar areas, such as LTE, LTE-A, CDMA, GSM, and other wireless technologies.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU. a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a CRC component 198 configured to generate cyclic redundancy check (CRC) bits corresponding to a payload; combine the CRC bits with source information and destination information associated with transmission of the payload to generate a modified CRC; and transmit, to a second UE, the modified CRC and the payload.

Referring again to FIG. 1, in certain aspects, the UE 104 may include a CRC component 198 configured to map to a payload one or more bits that correspond to source information and destination information associated with transmission of the payload; and transmit, to a second UE, the payload comprising the one or more bits that correspond to the source information and the destination information mapped to the payload.

Referring again to FIG. 1, in certain aspects, the UE 104 may include a CRC component 199 configured to receive, from a first UE, a modified CRC and a payload, wherein the modified CRC comprises CRC bits corresponding to the payload and source information and destination information associated with transmission of the payload; and compare the modified CRC with a list of source information and destination information to derive the CRC bits corresponding to the payload and the source and destination information associated with transmission of the payload.

Referring again to FIG. 1, in certain aspects, the UE 104 may include a CRC component 199 configured to receive, from a first UE, a payload comprising one or more bits that correspond to source information and destination information mapped to the payload, wherein the source information and the destination information are associated with transmission of the payload; calculate a cyclic redundancy check (CRC) based on the payload received from the first UE, wherein the source information and the destination information mapped to the payload is excluded from the calculation of the CRC; and compare the source information and the destination information mapped to the payload with a list of source information and destination information in response to a CRC check pass of the CRC.

Although the following description may be focused on 5G NR, the concepts described herein may be applicable to other similar areas, such as LTE, LTE-A, CDMA, GSM, and other wireless technologies.

FIG. 2 includes diagrams 200 and 210 illustrating example aspects of slot structures that may be used for sidelink communication (e.g., between UEs 104, RSU 407, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may comprise 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may include control information in PSCCH and some REs may include demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may comprise the data message described herein. The position of any of the data, DMRS. SCI, feedback, gap symbols, and/or LBT symbols may be different than the example illustrated in FIG. 2. Multiple slots may be aggregated together in some aspects.

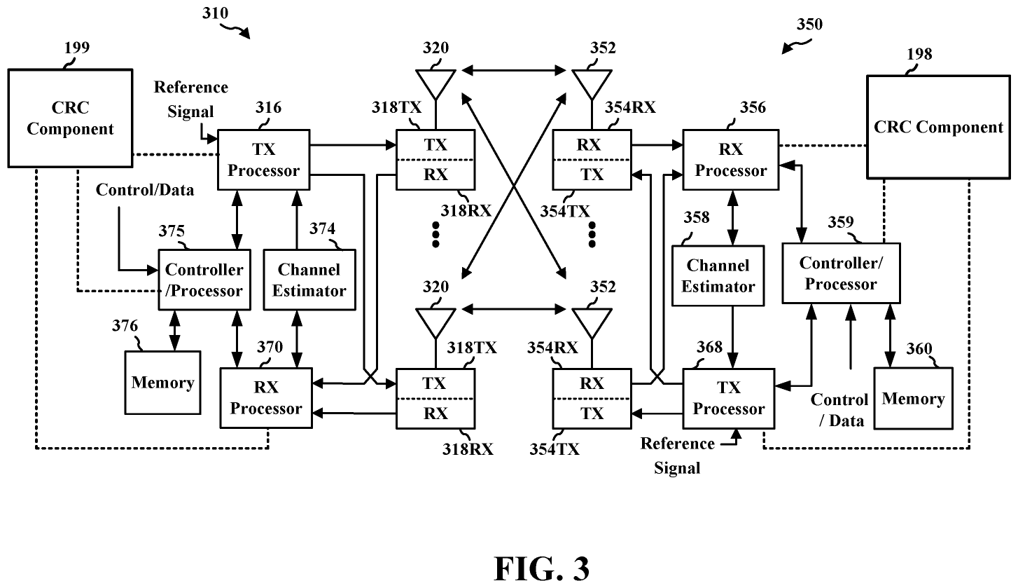

FIG. 3 is a block diagram of a first wireless communication device 310 in communication with a second wireless communication device 350 based on sidelink. In some examples, the devices 310 and 350 may communicate based on V2X or other D2D communication. The communication may be based on sidelink using a PC5 interface. The devices 310 and the 350 may comprise a UE, an RSU, a base station, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318TX. Each transmitter 318TX may modulate a radio frequency (RF) carrier with a respective spatial stream for transmission.

At the device 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The transmission is processed at the device 310 in a manner similar to that described in connection with the receiver function at the device 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

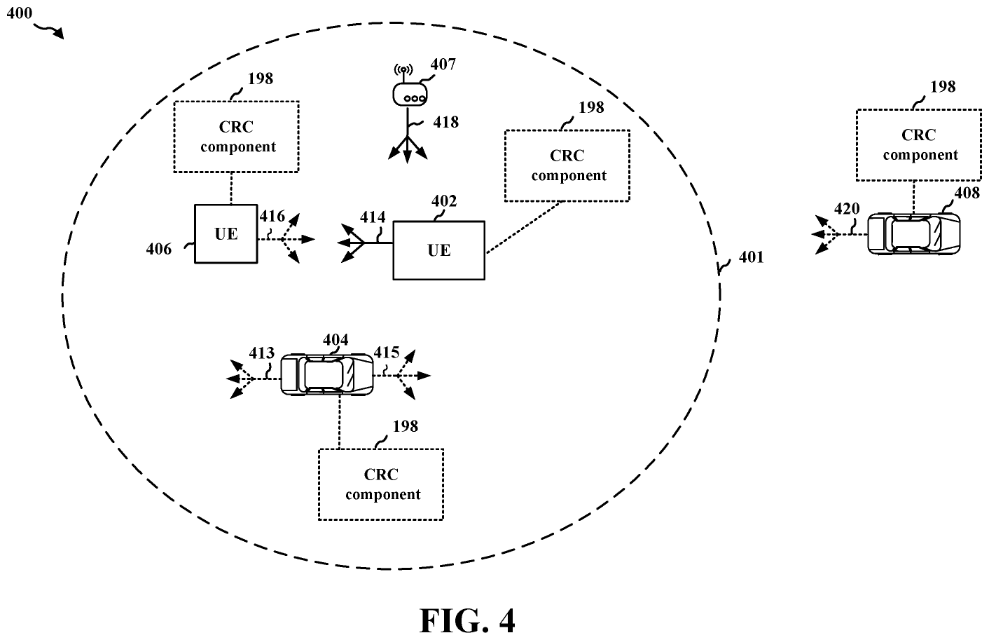

FIG. 4 illustrates an example 400 of sidelink communication between devices. The communication may be based on a slot structure comprising aspects described in connection with FIG. 2. For example, the UE 402 may transmit a sidelink transmission 414, e.g., comprising a control channel (e.g., PSCCH) and/or a corresponding data channel (e.g., PSSCH), that may be received by UEs 404, 406, 408. A control channel may include information (e.g., sidelink control information (SCI)) for decoding the data channel including reservation information, such as information about time and/or frequency resources that are reserved for the data channel transmission. For example, the SCI may indicate a number of TTIs, as well as the RBs that will be occupied by the data transmission. The SCI may also be used by receiving devices to avoid interference by refraining from transmitting on the reserved resources. The UEs 402, 404, 406, 408 may each be capable of sidelink transmission in addition to sidelink reception. Thus, UEs 404, 406, 408 are illustrated as transmitting sidelink transmissions 413, 415, 416, 420. The sidelink transmissions 413, 414, 415, 416, 420 may be unicast, broadcast or multicast to nearby devices. For example, UE 404 may transmit sidelink transmissions 413, 415 intended for receipt by other UEs within a range 401 of UE 404, and UE 406 may transmit sidelink transmission 416. Additionally, or alternatively, the RSU 407 may receive communication from and/or transmit communication 418 to UEs 402, 404, 406, 408. One or more of the UEs 402, 404, 406, 408 or the RSU 407 may comprise a CRC component 198 and/or 199 as described in connection with FIG. 1.

Sidelink communication may be based on different types or modes of resource allocation mechanisms. In a first resource allocation mode (which may be referred to herein as “Mode 1”), centralized resource allocation may be provided by a network entity. For example, a base station 102 may determine resources for sidelink communication and may allocate resources to different UEs 104 to use for sidelink transmissions. In this first mode, a UE receives the allocation of sidelink resources from the base station 102. In a second resource allocation mode (which may be referred to herein as “Mode 2”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink, may determine one or more radio resources in the time and frequency domain that are used by other devices in order to select transmission resources that avoid collisions with other devices. The sidelink transmission and/or the resource reservation may be periodic or aperiodic, where a UE may reserve resources for transmission in a current slot and up to two future slots (discussed below).

Thus, in the second mode (e.g., Mode 2), individual UEs may autonomously select resources for sidelink transmission, e.g., without a central entity such as a base station indicating the resources for the device. A first UE may reserve the selected resources in order to inform other UEs about the resources that the first UE intends to use for sidelink transmission(s).

In some examples, the resource selection for sidelink communication may be based on a sensing-based mechanism. For instance, before selecting a resource for a data transmission, a UE may first determine whether resources have been reserved by other UEs.

For example, as part of a sensing mechanism for resource allocation mode 2, the UE may determine (e.g., sense) whether the selected sidelink resource has been reserved by other UE(s) before selecting a sidelink resource for a data transmission. If the UE determines that the sidelink resource has not been reserved by other UEs, the UE may use the selected sidelink resource for transmitting the data, e.g., in a PSSCH transmission. The UE may estimate or determine which radio resources (e.g., sidelink resources) may be in-use and/or reserved by others by detecting and decoding sidelink control information (SCI) transmitted by other UEs. The UE may use a sensing-based resource selection algorithm to estimate or determine which radio resources are in-use and/or reserved by others. The UE may receive SCI from another UE that includes reservation information based on a resource reservation field comprised in the SCI. The UE may continuously monitor for (e.g., sense) and decode SCI from peer UEs. The SCI may include reservation information, e.g., indicating slots and RBs that a particular UE has selected for a future transmission. The UE may exclude resources that are used and/or reserved by other UEs from a set of candidate resources for sidelink transmission by the UE, and the UE may select/reserve resources for a sidelink transmission from the resources that are unused and therefore form the set of candidate resources. The UE may continuously perform sensing for SCI with resource reservations in order to maintain a set of candidate resources from which the UE may select one or more resources for a sidelink transmission. Once the UE selects a candidate resource, the UE may transmit SCI indicating its own reservation of the resource for a sidelink transmission. The number of resources (e.g., sub-channels per subframe) reserved by the UE may depend on the size of data to be transmitted by the UE. Although the example is described for a UE receiving reservations from another UE, the reservations may also be received from an RSU or other device communicating based on sidelink.

Sidelink transmission from one device to another device may be partitioned into physical channels, where the two main channels are PSCCH and PSSCH. The PSCCH carries information for demodulation of the PSSCH, known as SCI. Transmission of the sidelink transmission may be broadcast, groupcast, or unicast. As such, sidelink transmission may utilize a payload structure comprised of SCI1 and SCI2 in order to separate the control information and the additional information based on the desired cast type and the expected recipients. SCI1 is carried by the PSCCH and SCI2 is carried as part of the PSCCH. SCI2 may have multiple formats, where the specific type of format transmitted is indicated in SCI1.

SCI2 may be transmitted as part of the data resources of PSSCH. SCI2 may be transmitted in a single layer quadrature phase shift keying (QPSK). SCI2 may be transmitted starting from a first PSSCH DMRS symbols and may proceed along symbols according to SCI2 payload length and configured rate, which may be defined as a beta parameter. As such, based on the properties of SCI2 and its slot configuration (e.g., number of DMRS symbols, number of allocated subchannels per PSSCH, etc.), SCI2 may be spread all over the slot which may reduce the available resources for the PSSCH data.

Optimal demodulation of SCI2 may utilize processing of all the DMRS symbols (e.g., max of 4) based at least on the processing gain of all DMRS symbols to enhance performance for low mobility or an optimization of channel estimation based on DMRS symbols being as close as possible to SCI2 symbols for high mobility.

In some instances, control data based pruning may be utilized. Initial and basic pruning may be performed by checking PSCCH CRC. The amount of PSSCH data received from multiple users over the entire BW may be very large, and a device may be limited by the amount of RBs it is capable to process (e.g., required capability may be preconfigured to be non-overlapping N_{RBs} according to BW), additional level of pruning may be required, even for passing CRC PSCCH. Such additional pruning may be based on SCI1 payload, for example—checking the validity of values in specific fields (e.g., all reserved bits may be set to zero, and reception of non-zero reserved bit/bits may be used for pruning).

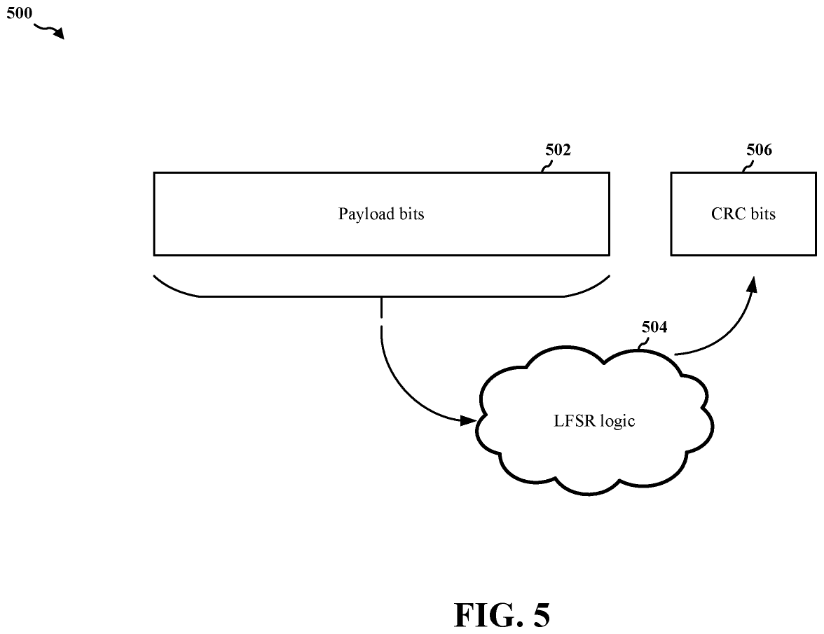

FIG. 5 provides an example of pruning. The diagram 500 of FIG. 5 may comprise 10 subchannels RB, starting at RB0, where the subchannel size may comprise 10 RBs. An allocation of 100 RBs may start at subchannel 0, while an allocation of 90 RBs may start at subchannel 1, for a total of 190 RBs. In some instances, a preconfigured maximum of N_{RB}=106 RBs may be required to be decoded. The sum of the allocation of RBs of diagram 500 exceeds the UE capability of 106 RBs, such that one of the allocations may be pruned.

Pruning inputs may indicate the manner of the pruning operation. For example, message priority (e.g., signaled by SCI1), layer 2 identifier (ID) may indicate additional information carried by SCI2 are 8 bits (out of 24 bits) of source ID and 16 bits (out of 24 bits) of destination ID may be used for determining if the data in the transport block is relevant for the device or not, such that the data may be pruned or not. In some instances, the lower layer may be exposed to a limited list of expected/required Source and destination IDs couples (“white list”). Discarding one of the two messages in the example above, before SCI2 demodulation and based on SCI1 only, may result in a denial of service scenario. For example, if the discarded message was addressed to the device, while the other, non-pruned, message was not addressed to the device.

Pruning methodology having an improved performance may be based on using SCI2 information, namely the source ID and destination ID. In order to minimize or save on redundant processing, pruning may be best held by SCI1 payload. Reducing non-essential processing may also reduce power consumption and chip temperature, which may improve lifetime and performance. In some instances, SCI2 demodulation performance optimization may include waiting until all PSSCH DMRS symbols are available, which may add latency to the overall demodulation timeline. SCI2 payload may be utilizing PSSCH resources that could be used for PSSCH data. As such, it may be advantageous to signal at least part of the SCI2 info on top of SCI1, without increasing SCI1 payload.

Aspects presented herein provide a configuration for SCI source and destination pruning. The disclosure may allow for the inclusion of source and destination information within SCI1 without increasing the payload size of SCI1. At least one advantage of SCI based pruning is a reduction in latency, such that the UE does not need to wait for SCI2 and/or a last DMRS symbol. At least another advantage of the disclosure is a minimization or prevention of denial of service in relation to SCI2. The SCI based pruning may result in a lower processing load, due in part to elimination of initiating demodulation processing of SCI2 for a message that could have been pruned earlier. In addition, SCI based pruning may result in a reduced SCI2 payload which may increase the PSSCH data available resources, which may lead to an increase in spectral efficiency.

In wireless communication, SCI1 may be carried by PSCCH having a 24 bit CRC, where the CRC is used to confirm that the data is valid, as shown for example in diagram 500 of FIG. 5. In the diagram 500 of FIG. 5, the CRC bits 506 may be generated by a transmitter (e.g., UE) based on a linear feedback shift register (LFSR) logic 504 processing the payload bits 502.

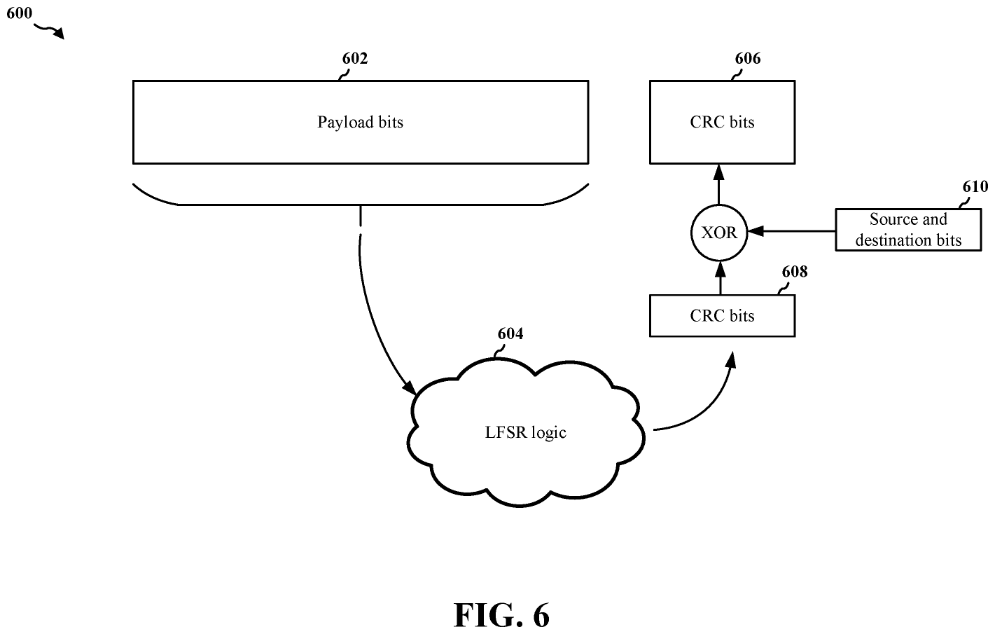

In some aspects, as shown for example in diagram 600 of FIG. 6, the transmitter (e.g., UE) may generate CRC bits 608 based on a LFSR logic 604 processing the payload bits 602. However, the CRC bits 608 may then be combined with the source and destination bits 610 to generate modified CRC bits 606. For example, the CRC bits 608 may be combined with the source and destination bits 610 based on an exclusive-OR (XOR) operation to generate the modified CRC bits 606. The source and destination bits 610 may be preconfigured or configurable at the transmitting device. A corresponding receiver (e.g., UE), the same processing may be performed on the payload bits, but the receiver may compare the modified CRC bits received from the transmitter with a list of source and destination identifiers (IDs) available at the receiver. In some instances, each entry within the list of source and destination IDs may comprise a single hypothesis. In some instances, the number of hypothesis may be based on the length of the list of source and destination IDs.

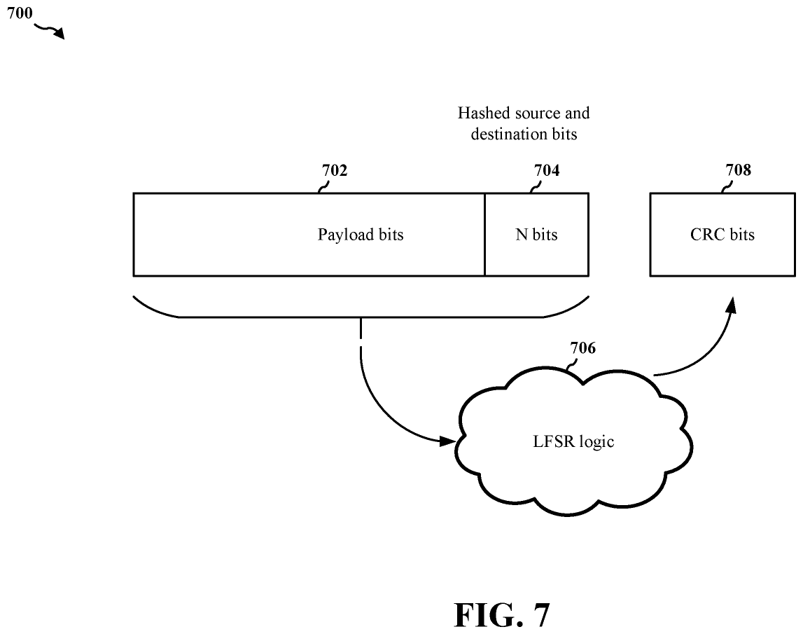

In some aspects, as shown for example in diagram 700 of FIG. 7, some bits of the source and destination information may be mapped to N bits 704 by a hash function. The N bits 704 may be added to the SCI information (e.g., payload bits 702). In some aspects, the N bits 704 may be added to reserve bits or additional bits within the SCI information (e.g., payload bits 702). The CRC bits 708 may be determined based on a LFSR logic 706 processing the combination of payload bits 702 and N bits 704. At a corresponding receiver (e.g., UE), the receiver may decode the payload bits 702 and N bits 704 based on a preconfigured or configurable list. The list may also comprise hash results for each entry, and the receiver may compare the decode payload hash bits to all the hash bits within the list. If a match is not found, then processing of the SCI2 does not commence, due to the source and destination not being comprised within the list at the receiver. If a match is found, then processing of the SCI2 may commence. There is a possibility that the source and destination may not be in the list at the receiver, such that the actual transmitted source and destination bits are hashed to same N bits as in one of the list entries, due in part to the many to one mapping. However, such a probability may be relatively low, based at least on the hash function, such that the chance of a denial of service and/or redundant processing remains relatively low.

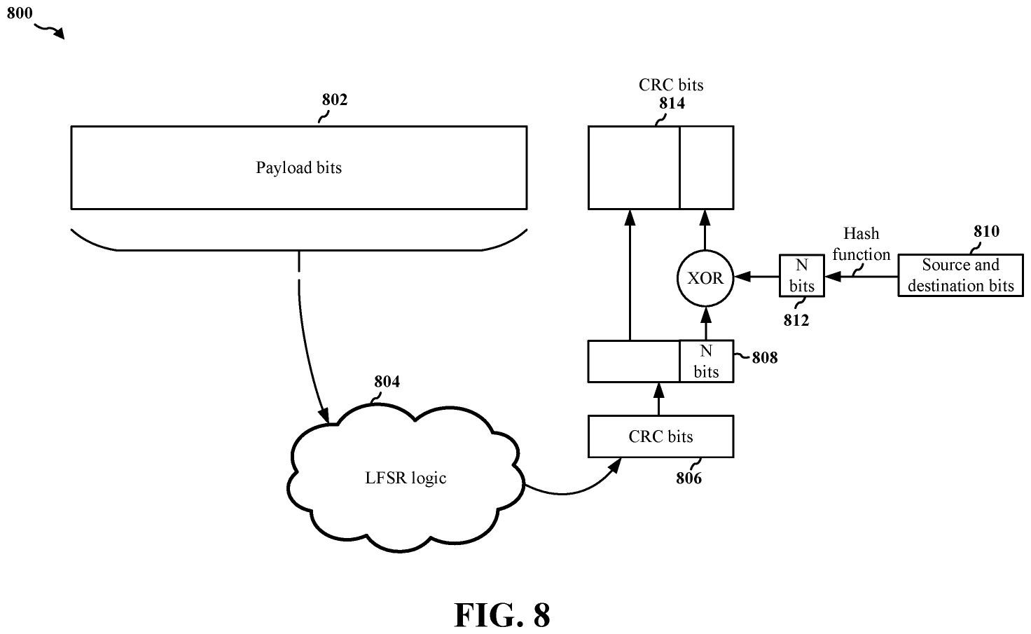

In some aspects, as shown for example in diagram 800 of FIG. 8, the transmitter (e.g., UE) may generate CRC bits 806 based on a LFSR logic 804 processing the payload bits 802. However, the CRC bits 806 may be mapped to N bits 808, via hash function. For example, the CRC bits 806 may comprise 24 bits, and the hash function may map some bits (e.g., 5 bits) to the N bits 808. The source and destination bits 810 may also be mapped to N bits 812 via hash function. For example, the source and destination bits 810 may comprise 24 bits, and the hash function may map some bits (e.g., 5 bits) to the N bits 812. The N bits 808 and the N bits 812 may be combined based on an XOR operation to form part of the modified CRC bits 814. The output of the XOR operation between the N bits 808 and N bits 812 may be stored in the least significant bits of the modified CRC bits 814. The modified CRC bits 814 may include the output of the XOR operation between the N bits 808 and N bits 812 and part of CRC bits 806 (e.g., 19 bits of most significant bits of CRC bits 806). A corresponding receiver (e.g., UE), the CRC may be calculated based on the decoded SCI bits, but a CRC check may be performed on the modified bits excluding the output of the XOR operation between the N bits 808 and N bits 812. For example, 24-N bits or the non-XORed bits (e.g., 19 bits of most significant bits of CRC bits 806) may be used by the receiver to perform the CRC check. If the CRC check of the non-XORed bits is successful, then the output of the XOR operation between the N bits 808 and N bits 812 (e.g., 5 bits) may be compared against each and every combination of a list comprising hash results for each entry of source and destination stored at the receiver. In instances where a CRC check was successful for SCI1, the received N bits corresponding to the output of the XOR operation between the N bits 808 and N bits 812 may be XORed with each entry of hashed bits within the list stored at the receiver. If a match is not found, then SCI2 processing does not commence, due to the source and destination not being comprised within the list at the receiver. If a match is found, then processing of the SCI2 may commence. There is a possibility that the source and destination may not be in the list at the receiver, such that the actual transmitted source and destination bits are hashed to same N bits as in one of the list entries, due in part to the many to one mapping. However, such a probability may be relatively low, based at least on the hash function, such that the chance of a denial of service and/or redundant processing remains relatively low.

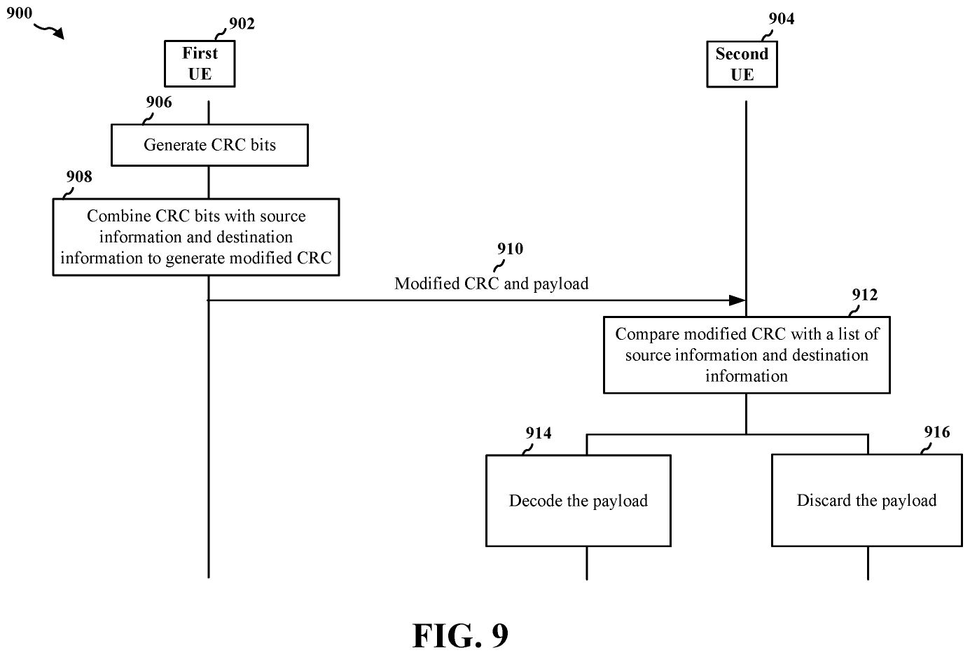

FIG. 9 is a call flow diagram 900 of signaling between a first UE 902 and a second UE 904. The first UE 902 may be configured to communicate with the base station (not shown). The first UE 902 and the second UE 904 may communicate with each other via sidelink communication. The first and second UEs may be configured to communicate with a network entity (e.g., base station). For example, in the context of FIG. 1, the first or second UE may each correspond to at least UE 104 and the network entity may correspond to base station 102. In another example, in the context of FIG. 3, the first UE may correspond to device 310 and the second UE may correspond to device 350.

At 906, the first UE 902 may generate CRC bits corresponding to a payload, as described in connection with at least FIG. 6 or 8. The payload may correspond to SCI of a sidelink transmission.

At 908, the first UE 902 may combine the CRC bits with source information and destination information, as described in connection with at least FIG. 6 or 8. The source information and the destination information may be associated with transmission of the payload. The UE may combine the CRC bits with the source information and the destination information associated with transmission of the payload to generate a modified CRC. In some aspects, the modified CRC may be generated based on an exclusive-OR (XOR) operation between the CRC bits corresponding to the payload and the source information and the destination information. In some aspects, the modified CRC may be generated based on an XOR operation between N bits of the CRC bits and N bits that correspond with the source information and the destination information. The source information and the destination information may be mapped to the N bits that correspond to source information and destination information based on a hash function.

At 910, the first UE 902 may transmit the modified CRC and the payload, as described in connection with at least FIG. 6 or 8. The first UE may transmit the modified CRC and the payload to the second UE 904. The second UE 904 may receive the modified CRC and the payload from the first UE 902. The first UE may transmit the modified CRC and the payload to the second UE via sidelink.

At 912, the second UE 904 may compare the modified CRC with a list of source information and destination information, as described in connection with at least FIG. 6 or 8. The second UE may compare the modified CRC with the list of source information and destination information to derive the CRC bits corresponding to the payload and the source and destination information associated with transmission of the payload.

In some aspects, for example at 914, the second UE 904 may decode the payload, as described in connection with at least FIG. 6 or 8. The second UE may decode the payload in response to a match between the modified CRC with at least one entry of the list of source information and destination information. The list of source information and destination information may be preconfigured into the second UE, or may be configurable.

In some aspects, for example at 916, the second UE 904 may discard the payload, as described in connection with at least FIG. 6 or 8. The second UE may discard the payload in response to a lack of a match between the modified CRC and the list of source information and destination information. The list of source information and destination information may be preconfigured into the second UE, or may be configurable.

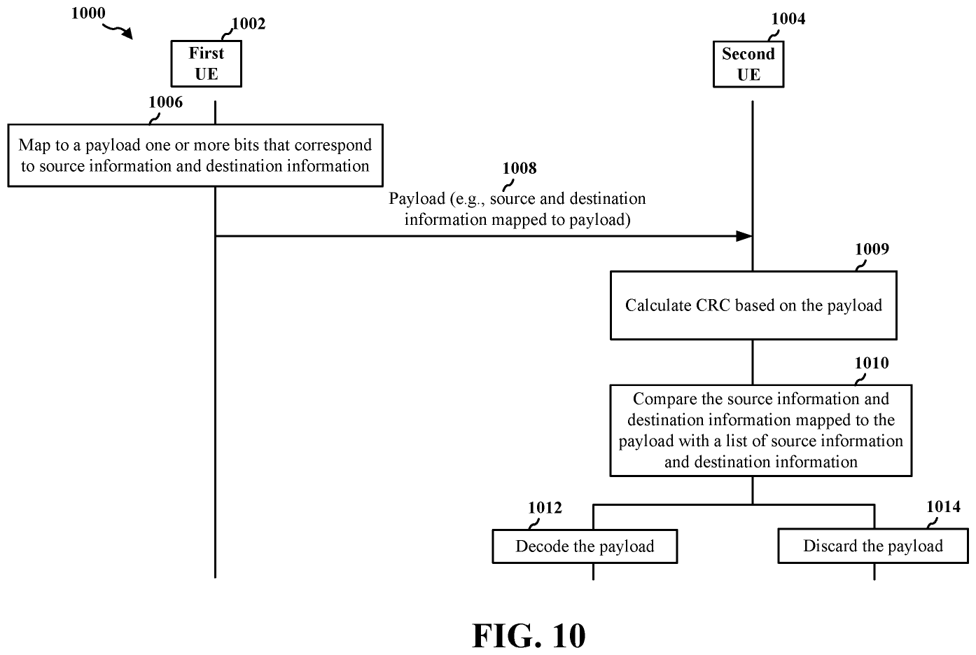

FIG. 10 is a call flow diagram 1000 of signaling between a first UE 1002 and a second UE 1004. The first UE 1002 may be configured to communicate with the base station (not shown). The first UE 1002 and the second UE 1004 may communicate with each other via sidelink communication. The first and second UEs may be configured to communicate with a network entity (e.g., base station). For example, in the context of FIG. 1, the first or second UE may each correspond to at least UE 104 and the network entity may correspond to base station 102. In another example, in the context of FIG. 3, the first UE may correspond to device 310 and the second UE may correspond to device 350.

At 1006, the first UE 1002 may map one or more bits that correspond to source information and destination information to a payload, as described in connection with at least FIG. 7. The mapped one or more bits may correspond to the source information and the destination information associated with transmission of the payload. In some aspects, the source information and the destination information may be mapped to the one or more bits that correspond to the source information and the destination information based on a hash function. In some aspects, the payload may correspond to sidelink control information of a sidelink transmission.

At 1008, the first UE 1002 may transmit the payload comprising the one or more bits that correspond to the source information and the destination information mapped to the payload, as described in connection with at least FIG. 7. The first UE may transmit the payload to the second UE 1004. The second UE 1004 may receive the payload from the first UE 1002.

At 1009, the second UE 1004 may calculate a CRC based on the payload received from the first UE 1002, as described in connection with at least FIG. 7. The second UE 1004 may calculate the CRC without taking into account the one or more bits that correspond to the source information and the destination information mapped to the payload. As such, the second UE 1004 determines the CRC of the payload excluding the source information and the destination information mapped into the payload. If a CRC check of the payload passes, then the second UE may proceed to process the one or more bits that correspond to the source information and the destination information mapped to the payload.

At 1010, the second UE 1004 may compare the source information and the destination information mapped to the payload with a list of source information and destination information, as described in connection with at least FIG. 7. The second UE may compare the source information and the destination information mapped to the payload with the list of source information and destination information to determine whether the second UE 1004 is an intended recipient of the transmission of the payload. The list of source information and destination information may be preconfigured into the second UE, or may be configurable.

In some aspects, for example at 1012, the second UE 1004 may decode the payload, as described in connection with at least FIG. 7. The second UE may decode the payload in response to a match between the one or more bits that correspond to the source information and the destination information mapped to the payload and at least one entry of the list of the source information and the destination information.

In some aspects, for example at 1014, the second UE 1004 may discard the payload, as described in connection with at least FIG. 7. The second UE may discard the payload in response to a lack of a match between the one or more bits that correspond to the source information and the destination information mapped to the payload and the list of source information and destination information. The list of source information and destination information may be preconfigured into the second UE, or may be configurable.

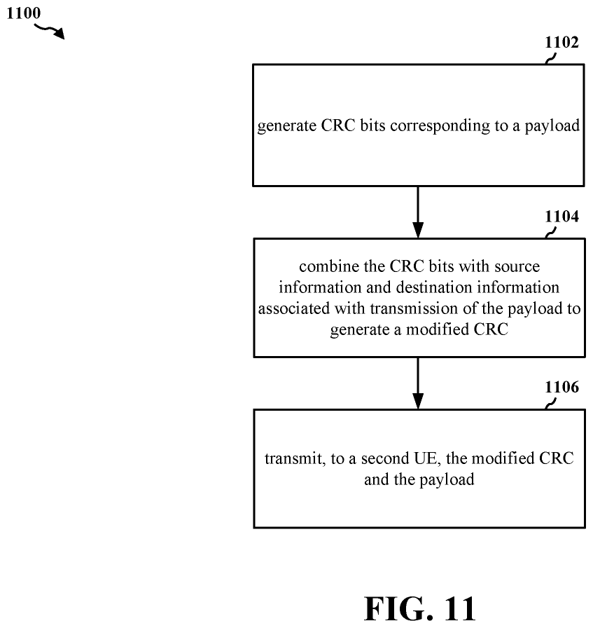

FIG. 11 is a flowchart 1100 of a method of wireless communication at a first UE. The method may be performed by a UE (e.g., the UE 104; the apparatus 1204). One or more of the illustrated operations may be omitted, transposed, or contemporaneous. The method may allow for the inclusion of source and destination information within SCI1.

At 1102, the first UE may generate CRC bits corresponding to a payload, as described in connection with at least FIG. 6 or 8. For example, 1102 may be performed by CRC component 198 of apparatus 1204. The payload may correspond to SCI of a sidelink transmission.

At 1104, the first UE may combine the CRC bits with source information and destination information, as described in connection with at least FIG. 6 or 8. For example, 1104 may be performed by CRC component 198 of apparatus 1204. The source information and the destination information may be associated with transmission of the payload. The UE may combine the CRC bits with the source information and the destination information associated with transmission of the payload to generate a modified CRC. In some aspects, the modified CRC may be generated based on an XOR operation between the CRC bits corresponding to the payload and the source information and the destination information. In some aspects, the modified CRC may be generated based on an XOR operation between N bits of the CRC bits and N bits that correspond with the source information and the destination information. The source information and the destination information may be mapped to the N bits that correspond to source information and destination information based on a hash function.

At 1106, the first UE may transmit the modified CRC and the payload, as described in connection with at least FIG. 6 or 8. For example, 1106 may be performed by CRC component 198 of apparatus 1204. The first UE may transmit the modified CRC and the payload to a second UE. The first UE may transmit the modified CRC and the payload to the second UE via sidelink.

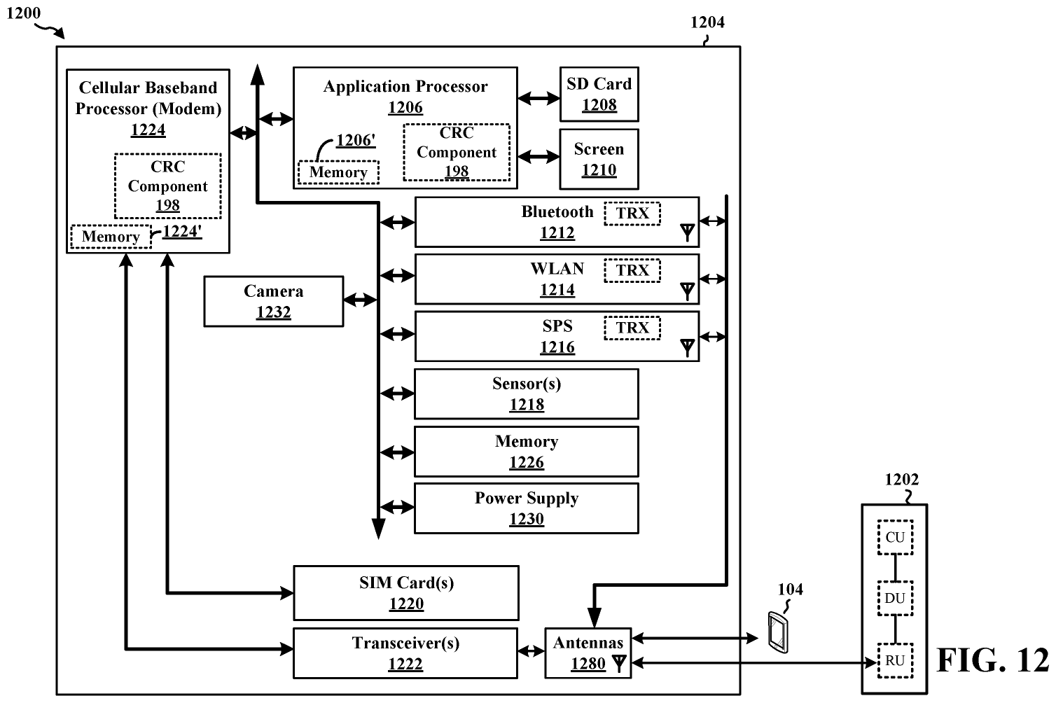

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor 1224 communicates through the transceiver(s) 1222 via one or more antennas 1280 with the UE 104 and/or with an RU associated with a network entity 1202. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described supra. The computer-readable medium/memory may also be used for storing data that is manipulated by the cellular baseband processor 1224/application processor 1206 when executing software. The cellular baseband processor 1224/application processor 1206 may be a component of the device 350 and may include the memory 360 and/or at least one of the TX processor 368, the RX processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see 350 of FIG. 3) and include the additional modules of the apparatus 1204.

As discussed supra, the component 198 is configured to generate CRC bits corresponding to a payload; combine the CRC bits with source information and destination information associated with transmission of the payload to generate a modified CRC; and transmitting, to a second UE, the modified CRC and the payload. The component 198 may be within the cellular baseband processor 1224, the application processor 1206, or both the cellular baseband processor 1224 and the application processor 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, includes means for generating CRC bits corresponding to a payload. The apparatus includes means for combining the CRC bits with source information and destination information associated with transmission of the payload to generate a modified CRC. The apparatus includes means for transmitting, to a second UE, the modified CRC and the payload. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

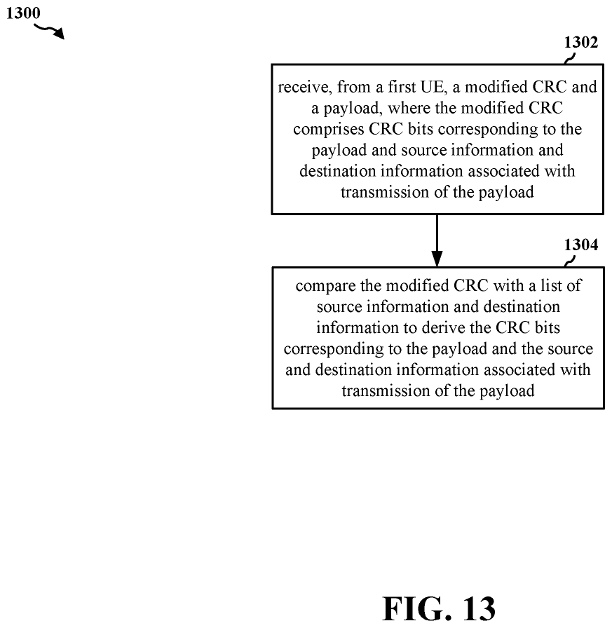

FIG. 13 is a flowchart 1300 of a method of wireless communication at a second UE. The method may be performed by a UE (e.g., the UE 104; the apparatus 1504). One or more of the illustrated operations may be omitted, transposed, or contemporaneous. The method may allow for the inclusion of source and destination information within SCI1.

At 1302, the second UE may receive a modified CRC and a payload, as described in connection with at least FIG. 6 or 8. For example, 1302 may be performed by CRC component 199 of apparatus 1504. The second UE may receive the modified CRC and the payload from a first UE. The modified CRC may comprise CRC bits corresponding to the payload and source information and destination information associated with transmission of the payload. In some aspects, the modified CRC may be based on an XOR operation between the CRC bits corresponding to the payload and the source information and the destination information. In some aspects, the modified CRC may be based on an XOR operation between N bits of the CRC bits and N bits that correspond with the source information and the destination information. The source information and the destination information may be mapped to the N bits that correspond to source information and destination information based on a hash function. In some aspects, the payload may correspond to sidelink control information associated with a sidelink transmission between the first UE and the second UE.

At 1304, the second UE may compare the modified CRC with a list of source information and destination information, as described in connection with at least FIG. 6 or 8. For example, 1304 may be performed by CRC component 199 of apparatus 1504. The second UE may compare the modified CRC with the list of source information and destination information to derive the CRC bits corresponding to the payload and the source and destination information associated with transmission of the payload.

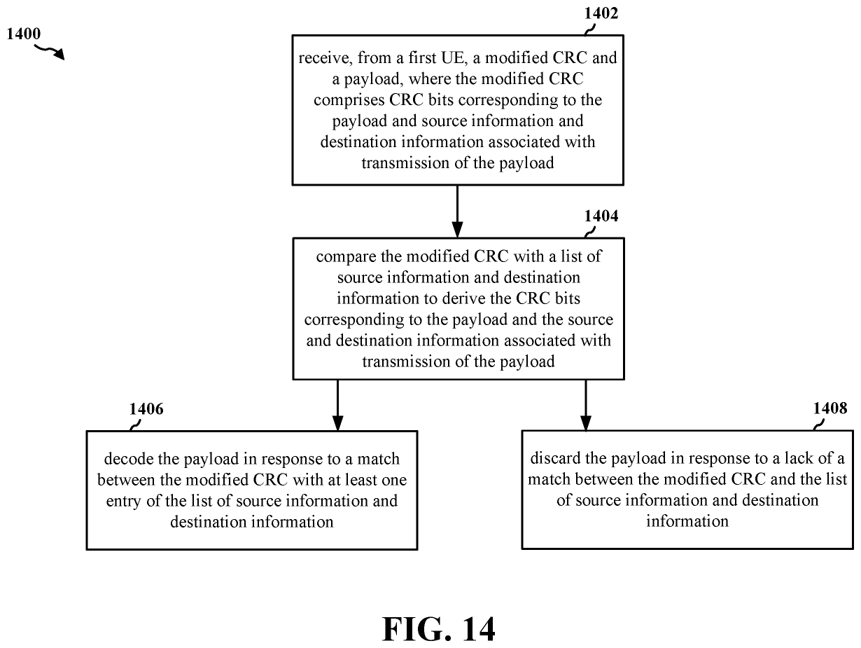

FIG. 14 is a flowchart 1400 of a method of wireless communication at a second UE. The method may be performed by a UE (e.g., the UE 104; the apparatus 1504). One or more of the illustrated operations may be omitted, transposed, or contemporaneous. The method may allow for the inclusion of source and destination information within SCI1.

At 1402, the second UE may receive a modified CRC and a payload, as described in connection with at least FIG. 6 or 8. For example, 1402 may be performed by CRC component 199 of apparatus 1504. The second UE may receive the modified CRC and the payload from a first UE. The modified CRC may comprise CRC bits corresponding to the payload and source information and destination information associated with transmission of the payload. In some aspects, the modified CRC may be based on an XOR operation between the CRC bits corresponding to the payload and the source information and the destination information. In some aspects, the modified CRC may be based on an XOR operation between N bits of the CRC bits and N bits that correspond with the source information and the destination information. The source information and the destination information may be mapped to the N bits that correspond to source information and destination information based on a hash function. In some aspects, the payload may correspond to sidelink control information associated with a sidelink transmission between the first UE and the second UE.

At 1404, the second UE may compare the modified CRC with a list of source information and destination information, as described in connection with at least FIG. 6 or 8. For example, 1404 may be performed by CRC component 199 of apparatus 1504. The second UE may compare the modified CRC with the list of source information and destination information to derive the CRC bits corresponding to the payload and the source and destination information associated with transmission of the payload.

At 1406, the second UE may decode the payload, as described in connection with at least FIG. 6 or 8. For example, 1406 may be performed by CRC component 199 of apparatus 1504. The second UE may decode the payload in response to a match between the modified CRC with at least one entry of the list of source information and destination information. The list of source information and destination information may be preconfigured into the second UE, or may be configurable.

At 1408, the second UE may discard the payload, as described in connection with at least FIG. 6 or 8. For example, 1408 may be performed by CRC component 199 of apparatus 1504. The second UE may discard the payload in response to a lack of a match between the modified CRC and the list of source information and destination information. The list of source information and destination information may be preconfigured into the second UE, or may be configurable.

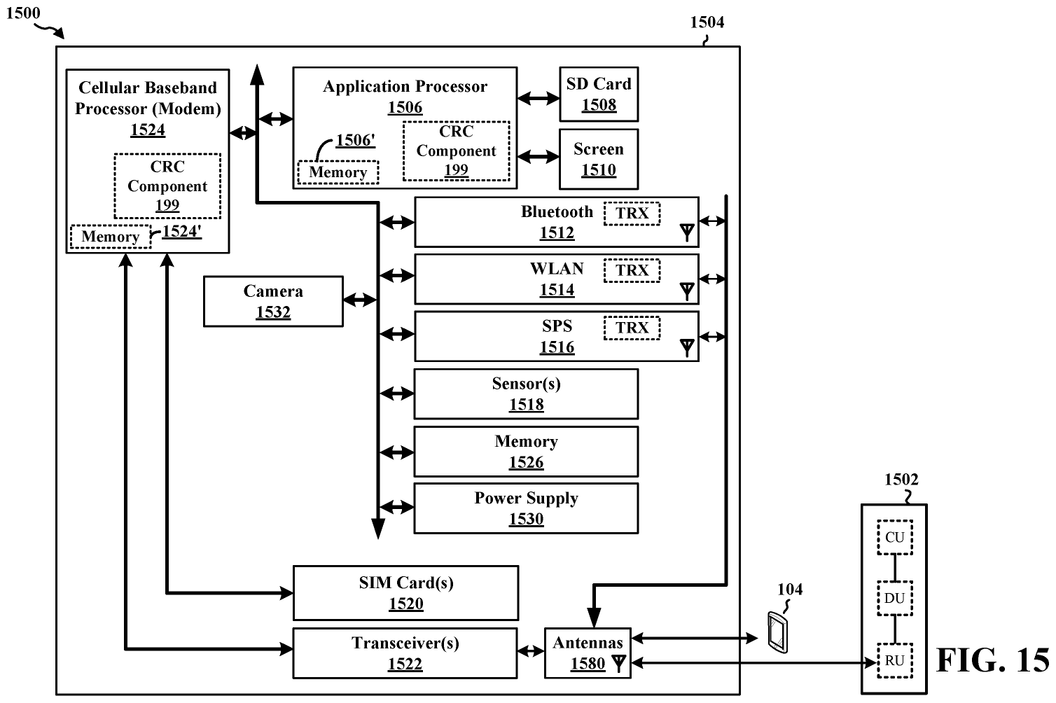

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include a cellular baseband processor 1524 (also referred to as a modem) coupled to one or more transceivers 1522 (e.g., cellular RF transceiver). The cellular baseband processor 1524 may include on-chip memory 1524′. In some aspects, the apparatus 1504 may further include one or more subscriber identity modules (SIM) cards 1520 and an application processor 1506 coupled to a secure digital (SD) card 1508 and a screen 1510. The application processor 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor 1524 communicates through the transceiver(s) 1522 via one or more antennas 1580 with the UE 104 and/or with an RU associated with a network entity 1502. The cellular baseband processor 1524 and the application processor 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor 1524 and the application processor 1506 are each responsible for general processing, including the execution of software stored on the computer-readable medium/memory. The software, when executed by the cellular baseband processor 1524/application processor 1506, causes the cellular baseband processor 1524/application processor 1506 to perform the various functions described supra. The computer-readable medium/memory may also be used for storing data that is manipulated by the cellular baseband processor 1524/application processor 1506 when executing software. The cellular baseband processor 1524/application processor 1506 may be a component of the device 310 and may include the memory 360 and/or at least one of the TX processor 368, the RX processor 356, and the controller/processor 359. In one configuration, the apparatus 1504 may be a processor chip (modem and/or application) and include just the cellular baseband processor 1524 and/or the application processor 1506, and in another configuration, the apparatus 1504 may be the entire UE (e.g., see 310 of FIG. 3) and include the additional modules of the apparatus 1504.

As discussed supra, the component 199 is configured to receive, from a first UE, a modified CRC and a payload, wherein the modified CRC comprises CRC bits corresponding to the payload and source information and destination information associated with transmission of the payload; and compare the modified CRC with a list of source information and destination information to derive the CRC bits corresponding to the payload and the source and destination information associated with transmission of the payload. The component 199 may be within the cellular baseband processor 1524, the application processor 1506, or both the cellular baseband processor 1524 and the application processor 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1504 may include a variety of components configured for various functions. In one configuration, the apparatus 1504, and in particular the cellular baseband processor 1524 and/or the application processor 1506, includes means for receiving, from a first UE, a modified CRC and a payload. The modified CRC comprises CRC bits corresponding to the payload and source information and destination information associated with transmission of the payload. The apparatus includes means for comparing the modified CRC with a list of source information and destination information to derive the CRC bits corresponding to the payload and the source and destination information associated with transmission of the payload. The apparatus further includes means for decoding the payload in response to a match between the modified CRC with at least one entry of the list of source information and destination information. The apparatus further includes means for discarding the payload in response to a lack of a match between the modified CRC and the list of source information and destination information. The means may be the component 199 of the apparatus 1504 configured to perform the functions recited by the means. As described supra, the apparatus 1504 may include the TX processor 316, the RX processor 370, and the controller/processor 375. As such, in one configuration, the means may be the TX processor 316, the RX processor 370, and/or the controller/processor 375 configured to perform the functions recited by the means.

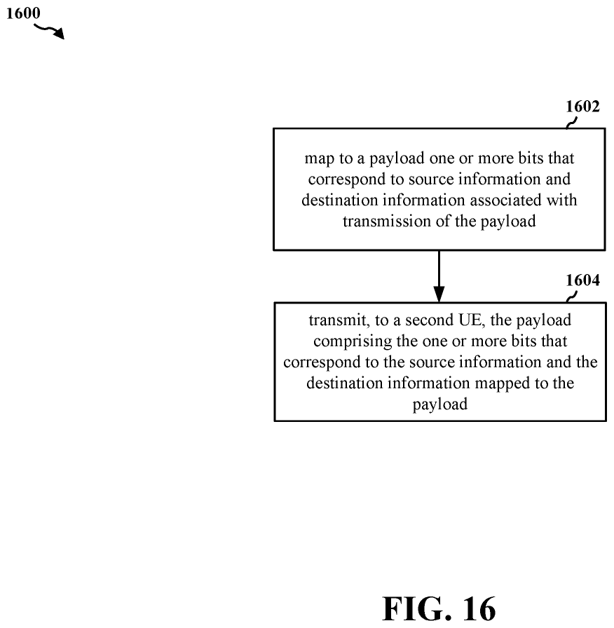

FIG. 16 is a flowchart 1600 of a method of wireless communication at a first UE. The method may be performed by a UE (e.g., the UE 104; the apparatus 1704). One or more of the illustrated operations may be omitted, transposed, or contemporaneous. The method may allow for the inclusion of source and destination information within SCI1.

At 1602, the first UE may map one or more bits that correspond to source information and destination information to a payload, as described in connection with at least FIG. 7. For example, 1602 may be performed by CRC component 198 of apparatus 1704. The mapped one or more bits may correspond to the source information and the destination information associated with transmission of the payload. In some aspects, the source information and the destination information may be mapped to the one or more bits that correspond to the source information and the destination information based on a hash function. In some aspects, the payload may correspond to sidelink control information of a sidelink transmission.

At 1604, the first UE may transmit the payload, as described in connection with at least FIG. 7. For example, 1604 may be performed by CRC component 198 of apparatus 1704. The first UE may transmit the payload comprising the one or more bits that correspond to the source information and the destination information mapped to the payload to a second UE.

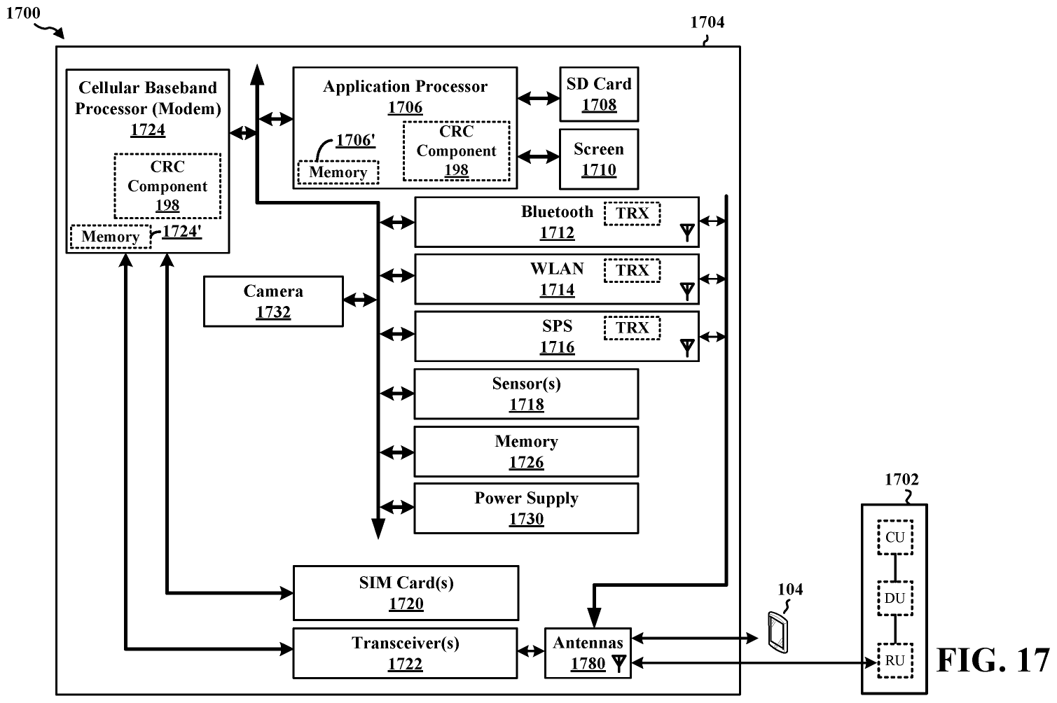

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor 1724 communicates through the transceiver(s) 1722 via one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra. The computer-readable medium/memory may also be used for storing data that is manipulated by the cellular baseband processor 1724/application processor 1706 when executing software. The cellular baseband processor 1724/application processor 1706 may be a component of the device 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., sec 350 of FIG. 3) and include the additional modules of the apparatus 1704.

As discussed supra, the component 198 is configured to map to a payload one or more bits that correspond to source information and destination information associated with transmission of the payload; and transmit, to a second UE, the payload comprising the one or more bits that correspond to the source information and the destination information mapped to the payload. The component 198 may be within the cellular baseband processor 1724, the application processor 1706, or both the cellular baseband processor 1724 and the application processor 1706. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1704 may include a variety of components configured for various functions. In one configuration, the apparatus 1704, and in particular the cellular baseband processor 1724 and/or the application processor 1706, includes means for mapping to a payload one or more bits that correspond to source information and destination information associated with transmission of the payload. The apparatus includes means for transmitting, to a second UE, the payload comprising the one or more bits that correspond to the source information and the destination information mapped to the payload. The means may be the component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

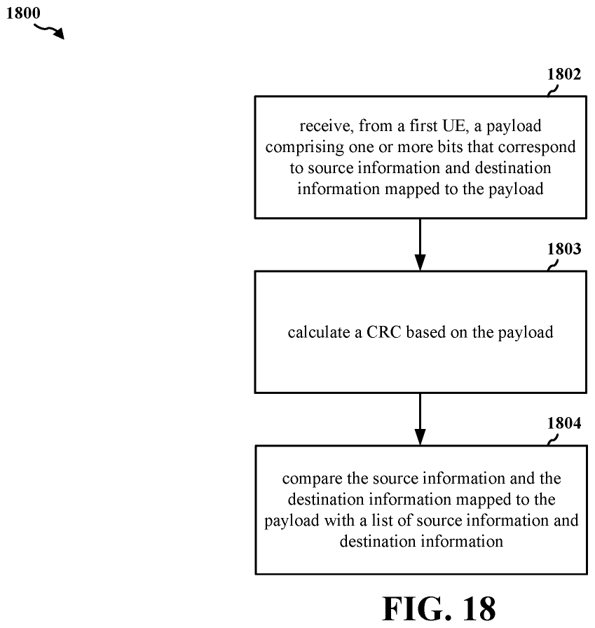

FIG. 18 is a flowchart 1800 of a method of wireless communication at a second UE. The method may be performed by a UE (e.g., the UE 104; the apparatus 2004). One or more of the illustrated operations may be omitted, transposed, or contemporaneous. The method may allow for the inclusion of source and destination information within SCI1.

At 1802, the second UE may receive a payload, as described in connection with at least FIG. 7. For example, 1802 may be performed by CRC component 199 of apparatus 2004. The second UE may receive the payload from a first UE. The payload may comprise one or more bits that correspond to source information and destination information mapped to the payload. The source information and the destination information may be associated with transmission of the payload. In some aspects, the source information and the destination information may be mapped to the one or more bits that correspond to source information and destination information based on a hash function. In some aspects, the payload may correspond to sidelink control information associated with a sidelink transmission between the first UE and the second UE.

At 1803, the second UE may calculate a CRC based on the payload received from the first UE 1002, as described in connection with at least FIG. 7. For example, 1803 may be performed by CRC component 199 of apparatus 2004. The second UE may calculate the CRC without taking into account the one or more bits that correspond to the source information and the destination information mapped to the payload. The second UE may determine the CRC of the payload excluding the one or more bits that correspond to the source information and the destination information mapped into the payload. If a CRC check of the payload passes, then the second UE may proceed to process the one or more bits that correspond to the source information and the destination information mapped to the payload.

At 1804, the second UE may compare the source information and the destination information mapped to the payload with a list of source information and destination information, as described in connection with at least FIG. 7. For example, 1804 may be performed by CRC component 199 of apparatus 2004. The second UE may compare the source information and the destination information mapped to the payload with the list of source information and destination information to determine whether the second UE is an intended recipient of the transmission of the payload. The list of source information and destination information may be preconfigured into the second UE, or may be configurable.

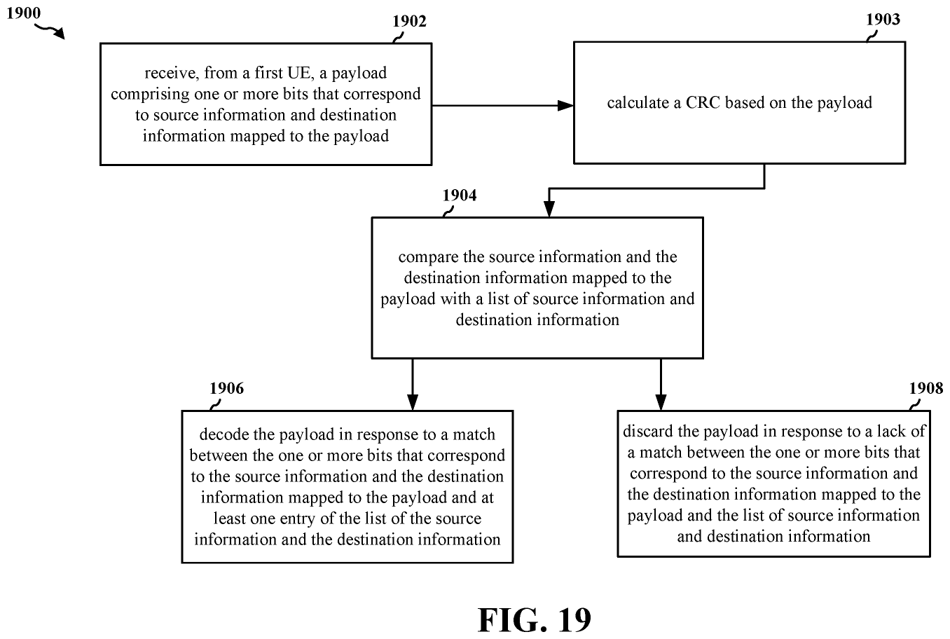

FIG. 19 is a flowchart 1900 of a method of wireless communication. The method may be performed by a UE (e.g., the UE 104; the apparatus 2004). One or more of the illustrated operations may be omitted, transposed, or contemporaneous. The method may allow for the inclusion of source and destination information within SCI1.

At 1902, the second UE may receive a payload, as described in connection with at least FIG. 7. For example, 1902 may be performed by CRC component 199 of apparatus 2004. The second UE may receive the payload from a first UE. The payload may comprise one or more bits that correspond to source information and destination information mapped to the payload. The source information and the destination information may be associated with transmission of the payload. In some aspects, the source information and the destination information may be mapped to the one or more bits that correspond to source information and destination information based on a hash function. In some aspects, the payload may correspond to sidelink control information associated with a sidelink transmission between the first UE and the second UE.

At 1903, the second UE may calculate a CRC based on the payload received from the first UE 1002, as described in connection with at least FIG. 7. For example, 1903 may be performed by CRC component 199 of apparatus 2004. The second UE may calculate the CRC without taking into account the one or more bits that correspond to the source information and the destination information mapped to the payload. The second UE may determine the CRC of the payload excluding the one or more bits that correspond to the source information and the destination information mapped into the payload. If a CRC check of the payload passes, then the second UE may proceed to process the one or more bits that correspond to the source information and the destination information mapped to the payload.

At 1904, the second UE may compare the source information and the destination information mapped to the payload with a list of source information and destination information, as described in connection with at least FIG. 7. For example, 1904 may be performed by CRC component 199 of apparatus 2004. The second UE may compare the source information and the destination information mapped to the payload with the list of source information and destination information to determine whether the second UE is an intended recipient of the transmission of the payload. The list of source information and destination information may be preconfigured into the second UE, or may be configurable.

At 1906, the second UE may decode the payload, as described in connection with at least FIG. 7. For example, 1906 may be performed by CRC component 199 of apparatus 2004. The second UE may decode the payload in response to a match between the one or more bits that correspond to the source information and the destination information mapped to the payload and at least one entry of the list of the source information and the destination information.

At 1908, the second UE may discard the payload, as described in connection with at least FIG. 7. For example, 1908 may be performed by CRC component 199 of apparatus 2004. The second UE may discard the payload in response to a lack of a match between the one or more bits that correspond to the source information and the destination information mapped to the payload and the list of source information and destination information. The list of source information and destination information may be preconfigured into the second UE, or may be configurable.

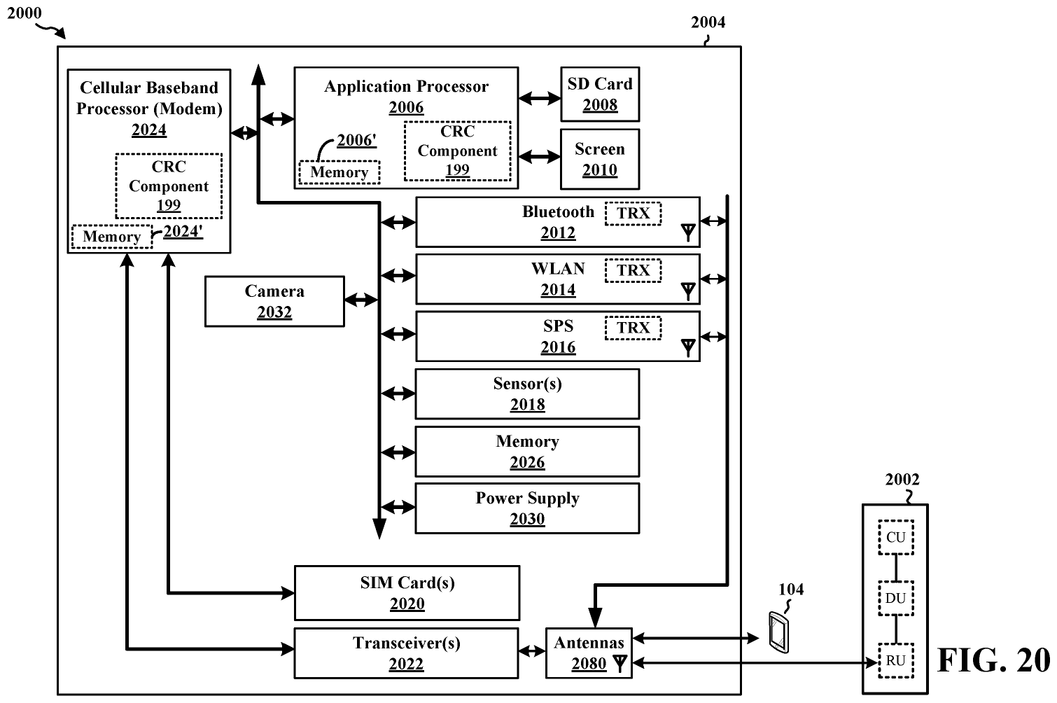

FIG. 20 is a diagram 2000 illustrating an example of a hardware implementation for an apparatus 2004. The apparatus 2004 may be a UE, a component of a UE, or may implement UE functionality. In some aspects, the apparatus 2004 may include a cellular baseband processor 2024 (also referred to as a modem) coupled to one or more transceivers 2022 (e.g., cellular RF transceiver). The cellular baseband processor 2024 may include on-chip memory 2024′. In some aspects, the apparatus 2004 may further include one or more subscriber identity modules (SIM) cards 2020 and an application processor 2006 coupled to a secure digital (SD) card 2008 and a screen 2010. The application processor 2006 may include on-chip memory 2006′. In some aspects, the apparatus 2004 may further include a Bluetooth module 2012, a WLAN module 2014, an SPS module 2016 (e.g., GNSS module), one or more sensor modules 2018 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2026, a power supply 2030, and/or a camera 2032. The Bluetooth module 2012, the WLAN module 2014, and the SPS module 2016 may include an on-chip transceiver (TRX) (or in some cases, just a receiver (RX)). The Bluetooth module 2012, the WLAN module 2014, and the SPS module 2016 may include their own dedicated antennas and/or utilize the antennas 2080 for communication. The cellular baseband processor 2024 communicates through the transceiver(s) 2022 via one or more antennas 2080 with the UE 104 and/or with an RU associated with a network entity 2002. The cellular baseband processor 2024 and the application processor 2006 may each include a computer-readable medium/memory 2024′, 2006′, respectively. The additional memory modules 2026 may also be considered a computer-readable medium/memory. Each computer-readable medium/memory 2024′, 2006′, 2026 may be non-transitory. The cellular baseband processor 2024 and the application processor 2006 are each responsible for general processing, including the execution of software stored on the computer-readable medium/memory. The software, when executed by the cellular baseband processor 2024/application processor 2006, causes the cellular baseband processor 2024/application processor 2006 to perform the various functions described supra. The computer-readable medium/memory may also be used for storing data that is manipulated by the cellular baseband processor 2024/application processor 2006 when executing software. The cellular baseband processor 2024/application processor 2006 may be a component of the device 310 and may include the memory 360 and/or at least one of the TX processor 368, the RX processor 356, and the controller/processor 359. In one configuration, the apparatus 2004 may be a processor chip (modem and/or application) and include just the cellular baseband processor 2024 and/or the application processor 2006, and in another configuration, the apparatus 2004 may be the entire UE (e.g., see 310 of FIG. 3) and include the additional modules of the apparatus 2004.

As discussed supra, the component 199 is configured to receive, from a first UE, a payload comprising one or more bits that correspond to source information and destination information mapped to the payload, wherein the source information and the destination information are associated with transmission of the payload; calculate a cyclic redundancy check (CRC) based on the payload received from the first UE, wherein the source information and the destination information mapped to the payload is excluded from the calculation of the CRC; and compare the source information and the destination information mapped to the payload with a list of source information and destination information in response to a CRC check pass of the CRC. The component 199 may be within the cellular baseband processor 2024, the application processor 2006, or both the cellular baseband processor 2024 and the application processor 2006. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 2004 may include a variety of components configured for various functions. In one configuration, the apparatus 2004, and in particular the cellular baseband processor 2024 and/or the application processor 2006, includes means for receiving, from a first UE, a payload comprising one or more bits that correspond to source information and destination information mapped to the payload, wherein the source information and the destination information are associated with transmission of the payload. The apparatus includes means for calculating a CRC based on the payload received from the first UE. The source information and the destination information mapped to the payload is excluded from the calculation of the CRC. The apparatus includes means for comparing the source information and the destination information mapped to the payload with a list of source information and destination information in response to a CRC check pass of the CRC. The apparatus further includes means for decoding the payload in response to a match between the one or more bits that correspond to the source information and the destination information mapped to the payload and at least one entry of the list of the source information and the destination information. The apparatus further includes means for discarding the payload in response to a lack of a match between the one or more bits that correspond to the source information and the destination information mapped to the payload and the list of source information and destination information. The means may be the component 199 of the apparatus 2004 configured to perform the functions recited by the means. As described supra, the apparatus 2004 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first UE comprising generating CRC bits corresponding to a payload; combining the CRC bits with source information and destination information associated with transmission of the payload to generate a modified CRC; and transmitting, to a second UE, the modified CRC and the payload.

Aspect 2 is the method of aspect 1, further includes that the modified CRC is generated based on an XOR operation between the CRC bits corresponding to the payload and the source information and the destination information.

Aspect 3 is the method of any of aspects 1 and 2, further includes that the modified CRC is generated based on an XOR operation between N bits of the CRC bits and N bits that correspond with the source information and the destination information.

Aspect 4 is the method of any of aspects 1-3, further includes that the source information and the destination information are mapped to the N bits that correspond to the source information and the destination information based on a hash function.

Aspect 5 is the method of any of aspects 1-4, further includes that the payload corresponds to sidelink control information.

Aspect 6 is an apparatus for wireless communication at a first UE including at least one processor coupled to a memory and at least one transceiver, the at least one processor configured to implement any of Aspects 1-5.

Aspect 7 is an apparatus for wireless communication at a first UE including means for implementing any of Aspects 1-5.

Aspect 8 is a computer-readable medium storing computer executable code, where the code when executed by a processor causes the processor to implement any of Aspects 1-5.

Aspect 9 is a method of wireless communication at a second UE comprising receiving. from a first UE, a modified CRC and a payload, wherein the modified CRC comprises CRC bits corresponding to the payload and source information and destination information associated with transmission of the payload; and comparing the modified CRC with a list of source information and destination information to derive the CRC bits corresponding to the payload and the source information and the destination information associated with the transmission of the payload.

Aspect 10 is the method of aspect 9, further includes that the modified CRC is based on an XOR operation between the CRC bits corresponding to the payload and the source information and the destination information.

Aspect 11 is the method of any of aspects 9 and 10, further includes that the modified CRC is based on an XOR operation between N bits of the CRC bits and N bits that correspond with the source information and the destination information.

Aspect 12 is the method of any of aspects 9-11, further includes that the source information and the destination information are mapped to the N bits that correspond to the source information and the destination information based on a hash function.

Aspect 13 is the method of any of aspects 9-12, further includes that the payload corresponds to sidelink control information.

Aspect 14 is the method of any of aspects 9-13, further including decoding the payload in response to a match between the modified CRC with at least one entry of the list of source information and destination information.

Aspect 15 is the method of any of aspects 9-14, further including discarding the payload in response to a lack of a match between the modified CRC and the list of source information and destination information.

Aspect 16 is an apparatus for wireless communication at a second UE including at least one processor coupled to a memory and at least one transceiver, the at least one processor configured to implement any of Aspects 9-15.

Aspect 17 is an apparatus for wireless communication at a second UE including means for implementing any of Aspects 9-15.

Aspect 18 is a computer-readable medium storing computer executable code, where the code when executed by a processor causes the processor to implement any of Aspects 9-15.

Aspect 19 is a method of wireless communication at a first UE comprising mapping to a payload one or more bits that correspond to source information and destination information associated with transmission of the payload; and transmitting, to a second UE, the payload comprising the one or more bits that correspond to the source information and the destination information mapped to the payload.

Aspect 20 is the method of aspect 19, further includes that the source information and the destination information are mapped to the one or more bits that correspond to the source information and the destination information based on a hash function.

Aspect 21 is the method of any of aspects 19 and 20, further includes that the payload corresponds to sidelink control information.

Aspect 22 is an apparatus for wireless communication at a first UE including at least one processor coupled to a memory and at least one transceiver, the at least one processor configured to implement any of Aspects 19-21.

Aspect 23 is an apparatus for wireless communication at a first UE including means for implementing any of Aspects 19-21.

Aspect 24 is a computer-readable medium storing computer executable code, where the code when executed by a processor causes the processor to implement any of Aspects 19-21.

Aspect 25 is a method of wireless communication at a second UE comprising receiving, from a first UE, a payload comprising one or more bits that correspond to source information and destination information mapped to the payload, wherein the source information and the destination information are associated with transmission of the payload; calculating a CRC based on the payload received from the first UE, wherein the source information and the destination information mapped to the payload is excluded from the calculation of the CRC; and comparing the source information and the destination information mapped to the payload with a list of source information and destination information in response to a CRC check pass of the CRC.

Aspect 26 is the method of aspect 25, further includes that the source information and the destination information are mapped to the one or more bits that correspond to the source information and the destination information based on a hash function.

Aspect 27 is the method of any of aspects 25 and 26, further includes that the payload corresponds to sidelink control information.

Aspect 28 is the method of any of aspects 25-27, further including decoding the payload in response to a match between the one or more bits that correspond to the source information and the destination information mapped to the payload and at least one entry of the list of the source information and the destination information.

Aspect 29 is the method of any of aspects 25-28, further including discarding the payload in response to a lack of a match between the one or more bits that correspond to the source information and the destination information mapped to the payload and the list of source information and destination information.

What is claimed is:

1. An apparatus for wireless communication at a first user equipment (UE), comprising:
at least one memory; and
at least one processor coupled to the at least one memory and, based at least in part on information stored in the at least one memory, the at least one processor, individually or in any combination, is configured to cause the apparatus to:
generate cyclic redundancy check (CRC) bits corresponding to a payload;
combine the CRC bits with source information and destination information associated with transmission of the payload to generate a modified CRC; and
transmit, to a second UE, the modified CRC and the payload.

2. The apparatus of claim 1, further comprising a transceiver coupled to the at least one processor, the transceiver being configured to:
transmit, to the second UE, the modified CRC and the payload.

3. The apparatus of claim 1, wherein the modified CRC is generated based on an exclusive-OR (XOR) operation between the CRC bits corresponding to the payload and the source information and the destination information.

4. The apparatus of claim 1, wherein the modified CRC is generated based on an exclusive-OR (XOR) operation between N bits of the CRC bits and N bits that correspond with the source information and the destination information.

5. The apparatus of claim 4, wherein the source information and the destination information are mapped to the N bits that correspond to the source information and the destination information based on a hash function.

6. The apparatus of claim 1, wherein the payload corresponds to sidelink control information.

7. An apparatus for wireless communication at a second user equipment (UE), comprising:
at least one memory; and
at least one processor coupled to the at least one memory and, based at least in part on information stored in the at least one memory, the at least one processor, individually or in any combination, is configured to cause the apparatus to:
receive, from a first UE, a modified cyclic redundancy check (CRC) and a payload, wherein the modified CRC comprises CRC bits corresponding to the payload and source information and destination information associated with transmission of the payload; and
compare the modified CRC with a list of source information and destination information to derive the CRC bits corresponding to the payload and the source information and the destination information associated with the transmission of the payload.

8. The apparatus of claim 7, further comprising a transceiver coupled to the at least one processor, the transceiver being configured to:
receive, from the first UE, the modified CRC and the payload, wherein the modified CRC comprises the CRC bits corresponding to the payload and the source information and the destination information associated with the transmission of the payload.

9. The apparatus of claim 7, wherein the modified CRC is based on an exclusive-OR (XOR) operation between the CRC bits corresponding to the payload and the source information and the destination information.

10. The apparatus of claim 7, wherein the modified CRC is based on an exclusive-OR (XOR) operation between N bits of the CRC bits and N bits that correspond with the source information and the destination information.

11. The apparatus of claim 10, wherein the source information and the destination information are mapped to the N bits that correspond to the source information and the destination information based on a hash function.

12. The apparatus of claim 7, wherein the payload corresponds to sidelink control information.

13. The apparatus of claim 7, wherein the at least one processor is configured to:
decode the payload in response to a match between the modified CRC with at least one entry of the list of source information and destination information.

14. The apparatus of claim 7, wherein the at least one processor is configured to:
discard the payload in response to a lack of a match between the modified CRC and the list of source information and destination information.

15. An apparatus for wireless communication at a first user equipment (UE), comprising:
at least one memory; and
at least one processor coupled to the at least one memory and, based at least in part on information stored in the at least one memory, the at least one processor, individually or in any combination, is configured to cause the apparatus to:
map to a payload one or more bits that correspond to source information and destination information associated with transmission of the payload; and
transmit, to a second UE, the payload comprising the one or more bits that correspond to the source information and the destination information mapped to the payload.

16. The apparatus of claim 15, further comprising a transceiver coupled to the at least one processor, the transceiver being configured to:
transmit, to the second UE, the payload comprising the one or more bits that correspond to the source information and the destination information mapped to the payload.

17. The apparatus of claim 15, wherein the source information and the destination information are mapped to the one or more bits that correspond to the source information and the destination information based on a hash function.

18. The apparatus of claim 15, wherein the payload corresponds to sidelink control information.

19. An apparatus for wireless communication at a second user equipment (UE), comprising:
at least one memory; and
at least one processor coupled to the at least one memory and, based at least in part on information stored in the at least one memory, the at least one processor, individually or in any combination, is configured to cause the apparatus to:
receive, from a first UE, a payload comprising one or more bits that correspond to source information and destination information mapped to the payload, wherein the source information and the destination information are associated with transmission of the payload;
calculate a cyclic redundancy check (CRC) based on the payload received from the first UE, wherein the source information and the destination information mapped to the payload is excluded from the calculation of the CRC; and
compare the source information and the destination information mapped to the payload with a list of source information and destination information in response to a CRC check pass of the CRC.

20. The apparatus of claim 19, further comprising a transceiver coupled to the at least one processor, the transceiver being configured to:
receive, from the first UE, the payload comprising the one or more bits that correspond to the source information and the destination information mapped to the payload, wherein the source information and the destination information are associated with the transmission of the payload.

21. The apparatus of claim 19, wherein the source information and the destination information are mapped to the one or more bits that correspond to the source information and the destination information based on a hash function.

22. The apparatus of claim 19, wherein the payload corresponds to sidelink control information.

23. The apparatus of claim 19, wherein the at least one processor is configured to:
decode the payload in response to a match between the one or more bits that correspond to the source information and the destination information mapped to the payload and at least one entry of the list of the source information and the destination information.

24. The apparatus of claim 19, wherein the at least one processor is configured to:
discard the payload in response to a lack of a match between the one or more bits that correspond to the source information and the destination information mapped to the payload and the list of source information and destination information.
